(19) United States
(12) Patent Application Publication
(10) Pub. No.: US 2010/0208237 A1
(43) Pub. Date: Aug. 19, 2010

(54) POLYMERIC SUBSTRATES FOR RAMAN SPECTROSCOPY

(75) Inventors: Eric Mazur, Concord, MA (US); Eric Diebold, Cambridge, MA (US); Tommaso Baldacchini, Irvine, CA (US)

Correspondence Address: NUTTER MCCLENNEN & FISH LLP, SEAPORT WEST, 155 SEAPORT BOULEVARD, BOSTON, MA, 02210-2604, US

(73) Assignee: PRESIDENT & FELLOWS OF HARVARD COLLEGE, Cambridge, MA (US)

(21) Appl. No.: 12/094,719

(22) PCT Filed: Jan. 22, 2008
(86) PCT No.: PCT/US08/51632

§ 371 Date: Apr. 28, 2010

Related U.S. Application Data
(60) Provisional application No. 60/886,256, filed on Jan. 23, 2007.

(51) Int. Cl. G01J 3/44; B05D 3/06; G01J 3/00; B32B 3/00

(52) U.S. Cl. 356/51; 427/554; 427/515; 427/555; 356/300; 356/301; 428/141

(57) ABSTRACT

The present invention generally provides substrates for use in a variety of analytical and/or diagnostic applications as well as optical systems that employ them, in particular systems based on surface enhanced Raman spectroscopy (SERS). In one aspect, the invention provides polymeric substrates having conductive surfaces that exhibit micron-sized, and preferably submicron-sized, structures. In other aspects, methods for fabricating such substrates are disclosed, including a step of irradiating a mold surface with a plurality of short laser pulses to form micron-sized or submicron-sized structures and the mold surface and generating the polymeric substrate by replication from the mold surface.

### RELATED APPLICATIONS

This application claims priority to a provisional application filed on Jan. 23, 2007 entitled “Polymeric Substrates for Raman Spectroscopy” having a Ser. No. 60/886,256.

### BACKGROUND

The present invention relates generally to methods for fabricating substrates suitable for use in analytical and diagnostic optical systems, and in particular, substrates for use in Raman spectroscopy.

Raman spectroscopy can be employed as an analytical as well as a diagnostic technique in a variety of applications, such as material characterization and identification. It relies on inelastic scattering of incident photons by a molecule, via coupling to its vibrational modes, to provide an essentially unique signature for that molecule. In particular, such inelastic scattering (commonly known as Raman scattering) can cause a decrease or an increase in the scattered photon energy, which appear as “Stokes” and “anti-Stokes” peaks in a wavelength-dispersed spectrum of the scattered photons. A drawback of Raman spectroscopy is the relatively few incidences of such inelastic scattering. The probability that a scattering event will occur is typically called “cross-section,” which is expressed in terms of area.

Raman scattering cross-sections can, however, be significantly enhanced by placing the molecule on or near a conductive surface. Such a mode of performing Raman spectroscopy is commonly known as surface enhanced Raman spectroscopy (SERS). Although SERS is a promising technique for extending the use of Raman spectroscopy to a variety of new applications, its use is currently limited due to a dearth of reliable, high performance substrates.

Accordingly, there is a need for substrates for use in SERS, as well as other applications, that can provide a high degree of reliability and performance. There is also a need for methods of fabricating such substrates with a high degree of reproducibility, which can be easily and, preferably inexpensively, implemented.

### SUMMARY

In one aspect, the present invention provides a method for fabricating a polymeric substrate, which comprises exposing a surface of a mold material, which can be a semiconductor, glass or metal or any other material suitable for structuring (e.g., micro- and/or nanostructuring), to a plurality of short laser pulses to generate micron-sized, and preferably submicron-sized, structures (e.g., in the form of spikes) on that surface. In a related aspect, the semiconductor is exposed to the laser pulses while in contact with a liquid, e.g., a polar or non-polar liquid, such as water, alcohol or oil.

The structured semiconductor surface can then be utilized to generate a polymeric substrate having a surface that exhibits micron-sized, and preferably submicron-sized, structures that are substantially negative or positive replications of the structures on the semiconductor surface. This is followed by depositing a metal layer, e.g., one having a thickness in a range of about 10 nm to about 1000 nm (and preferably in a range of about 50 nm to about 120 nm), over the polymeric replica surface.

Further, the metal layer exhibits micron-sized, and preferably submicron-sized, structures (undulations) that correspond substantially to the structures on the underlying polymeric surface.

In some embodiments, a discontinuous metal coating is disposed on the structured surface of the polymeric substrate such that the metal covers portions of the polymeric surface while leaving other portions uncovered. The metal covering portions of the polymeric surface can exhibit structures similar to those on the underlying polymeric surface.

In some cases, the polymeric substrate can be generated by disposing a curable polymer over the structured semiconductor surface, followed by curing the polymer and removing the cured polymer from the semiconductor surface to form a polymeric substrate having a surface that exhibits micron-sized, and preferably submicron-sized, features that represent substantially negative replications of the underlying semiconductor substrate

In a related aspect, such a polymeric substrate representing a negative mold of the structured semiconductor surface can be employed to form another polymeric substrate having a surface that is a positive replica of the structured semiconductor surface. For example, a curable polymer can be disposed over the polymeric surface exhibiting a negative replication of the structured semiconductor surface, followed by curing the disposed polymer and separating the two polymeric substrates to generate another polymeric substrate having a surface exhibiting micron-sized, and preferably submicron-sized, structures that are substantially positive replications of the structured on the semiconductor surface.

A variety of thermally and/or optically curable polymers can be employed in the practice of the invention. Some of such polymers can include, without limitation, hard-poly(dimethylsiloxane), polyurethane, poly(dimethylsiloxane), photoresists (PMMA, SU-8). By way of example, in some cases, the polymers can be cured by exposure to a temperature in a range of about, e.g., 15° C. to about 100° C., for a duration, e.g., in a range of about 1 minute to about 48 hours. In other cases, the polymers can be cured by exposure to radiation, e.g., UV radiation.

In another aspect, a method of fabricating a polymeric article is disclosed that includes forming a textured surface by irradiating a substrate surface, e.g., a semiconductor surface, with a plurality of short laser pulses, preferably while the substrate surface is in contact with a liquid, and generating a polymeric negative mold of at least a portion of said textured surface. The negative mold can then be employed to generate a polymeric reproduction of the textured substrate surface.

In yet another aspect, the invention provides a method of forming a polymeric substrate by irradiating a semiconductor surface with a plurality of short laser pulses to form nanosized structures on that surface. A curable polymer can be disposed over at least a portion of the irradiated semiconductor surface to generate a negative mold of that surface, and the negative mold can be utilized to fabricate a polymeric substrate, e.g., one having a surface that exhibits substantial replications of the structures on the semiconductor surface.

In a related aspect, a metallic layer can be disposed over the structured surface of the polymeric substrate to generate a polymeric sensing substrate suitable for use in a variety of applications, including analytical assays. In some cases, rather than disposing a continuous metallic layer over the structured polymeric surface, a discontinuous metal coating can be formed on that surface. By way of example, such polymeric sensing substrates can be employed in surface enhanced Raman spectroscopy.

In another aspect, an optical system is disclosed that includes a sensing substrate comprising a polymeric material having at least an electrically conductive surface exhibiting a plurality of micron-sized or submicron-sized ridges, where the conductive surface is adapted for contact with one or more analytes. The conductive surface can comprise a metallic layer having a thickness in a range of about 10 nm to about 1000 nm (and preferably in a range of about 50 nm to about 120 nm). In some cases, the conductive surface can comprise a discontinuous metal coating that covers portions of an underlying surface of the polymeric material (e.g., with a metal thickness in a range of about 10 nm to about 1000 nm) while leaving other portions uncovered. The system further includes a radiation source for directing radiation, e.g., radiation having one or more wavelengths in a range of about 200 nm to about 2000 nm, to the substrate so as to cause interaction of the radiation with one or more analytes in contact with, or in proximity of, the metal-covered substrate surface. An analyzer, which is adapted to detect at least a portion of radiation returning from the substrate in response to the illuminating radiation, analyzes the returning radiation to generate spectroscopic information regarding at least one of the analytes.

In a related aspect, in the above optical system, the polymeric material is substantially transparent to the radiation such that the radiation can be directed to a back surface of the polymeric substrate (a surface opposed to the conductive surface) so as to excite, after passage through a portion of the substrate, one or more molecular species that are in contact with, or in proximity of, the conductive surface. Alternatively, in some embodiments, the radiation can directly illuminate the conductive surface.

In some cases, the analyte includes one or more Raman active constituents, and the analyzer comprises a Raman spectrometer that can provide one or more surface enhanced Raman spectra of those constituents. Further, in some embodiments, the analyzer can be configured to compare the Raman spectra with one or more reference spectra so as to generate information regarding the analyte and/or the environment in which the analyte is contained.

In another aspect, a method of performing surface enhanced Raman spectroscopy (SERS) is disclosed that includes providing a polymeric substrate comprising a textured surface that is a substantial replica of a textured surface generated by irradiating a substrate surface with a plurality of short laser pulses, where the polymeric textured surface includes a metallic coating (e.g., a continuous metal layer or a discontinuous coating) on at least a portion thereof. The method further calls for placing at least a portion of the metallic layer in contact with a Raman active analyte, and directing radiation to said textured polymeric surface. At least a portion of radiation returning from said metal-coated polymeric surface in response to illumination thereof can be analyzed to generate one or more Raman spectra of the analyte.

Further understanding of the invention can be obtained by reference to the following detailed description in conjunction with the associated drawings, which are briefly described below.

### BRIEF DESCRIPTION OF THE DRAWINGS

FIG. 1 is a flow chart depicting various steps in some exemplary embodiments of methods of the invention for generating polymeric sensing substrates,

FIG. 2 schematically depicts an exemplary apparatus suitable for generating micron-sized or submicron-sized structures on a substrates' surface, such as a semiconductor surface,

FIG. 3 shows nanosized structures, in the form of spikes, formed on silicon surface by exposing a silicon substrate's surface to a plurality of femtosecond pulses while the surface is in contact with water,

FIG. 4A schematically shows (not to scale) a micro- or nanostructured semiconductor surface on which a curable polymer is disposed,

FIG. 4B shows (not to scale) a polymeric substrate according to an embodiment of the invention having a surface exhibiting micro- or nanosized ridges, where the polymeric substrate can be formed by curing the curable polymer shown in FIG. 4A and separating the cured polymer from the underlying semiconductor surface,

FIG. 4C schematically shows (not to scale) the polymeric substrate of FIG. 4B with a thin metallic layer deposited over its structured surface such that the metallic layer exhibits undulations substantially corresponding to the structures on the underlying polymeric surface,

FIG. 4D is a schematic side view (not to scale) of a polymeric substrate according to an embodiment of the invention having a structured surface on which a discontinuous metal coating is disposed,

FIG. 4E is a perspective view of the polymeric substrate of FIG. 4D,

FIG. 5A schematically shows (not to scale) a curable polymer disposed over the structured surface of the polymeric substrate shown in FIG. 4B,

FIG. 5B schematically shows (not to scale) a polymeric substrate obtained by curing the curable polymer shown in FIG. 5A,

FIG. 5C schematically shows (not to scale) a polymeric sensing substrate in accordance with an embodiment of the invention formed by depositing a thin metallic layer over the polymeric substrate shown in FIG. 5B,

FIG. 6 schematically depicts an optical system according to an embodiment of the invention that employs a polymeric sensing substrate according to the teachings of the invention,

FIG. 7A schematically depicts an optical system representing an exemplary implementation of the optical system of FIG. 6,

FIG. 7B schematically depicts an optical system according to another embodiment of the invention that utilizes a polymeric sensing substrate according to the teachings of the invention,

FIG. 8A is a surface enhanced Raman spectrum of a monolayer of Benzenethiol disposed on a structured conductive surface of a polymeric substrate according to the teachings of the invention, which is obtained by back illumination of the substrate,

FIG. 8B is a surface enhanced Raman spectrum of a monolayer of Benzenethiol disposed on a structured conductive surface of a polymeric substrate according to the teachings of the invention, which is obtained by front illumination of the substrate, and

FIG. 9 is a control Raman spectrum of neat, bulk Benzenethiol.

### DETAILED DESCRIPTION

The present invention generally provides sensing substrates that are suitable for use in a variety of applications, including surface enhanced Raman spectroscopy (SERS), as well as optical systems that employ such substrates, e.g., for interrogating molecular species in a selected environment. In some embodiments, a surface of a semiconductor substrate, e.g., silicon, is exposed to a plurality of short laser pulses (e.g., sub-picosecond laser pulses) to generate micron-sized, and preferably submicron-sized, structures (e.g., in the form of spikes) on that surface. The structured surface can then be coated with a thin layer of a metal, e.g., silver or gold, to be used as a substrate for SERS, or other applications. The term “structured surface,” as used herein, refers to a surface that exhibits undulations (e.g., spikes) with peak-to-trough excursions (e.g., amplitudes) of a few microns (e.g., less than about 20 microns), and preferably less than about 1 micron, and more preferably less than about 100 nanometers (e.g., in a range of about 1 nm to about 50 nm). The “structured surface” can exhibit a surface roughness with amplitudes less than about 1 micron, and preferably less than about 100 nanometers, and more preferably less than about 50 nm. The structured semiconductor substrate can be used to generate a polymeric substrate having a surface with microns-sized, and preferably submicron-sized, ridges. The ridges can be coated with a thin metallic layer to generate a polymeric substrate suitable for use in SERS, or other applications. In some embodiments, a discontinuous metal coating can be disposed on the structured polymer surface to form a substrate suitable for use in SERS or other applications.

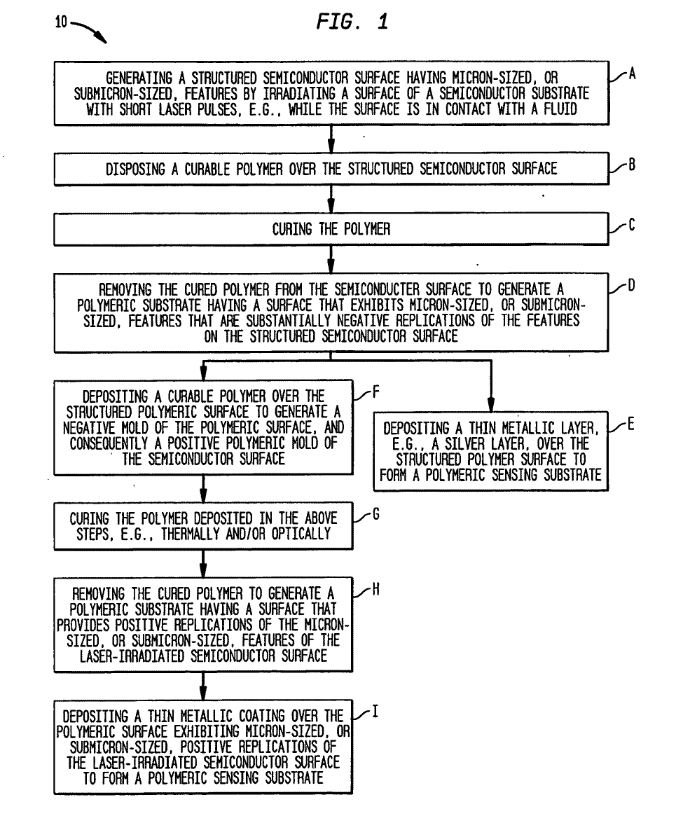

With reference to a flow chart 10 shown in FIG. 1, an exemplary method in accordance with one embodiment of the invention for fabricating a polymeric substrate, e.g., one suitable for use in surface enhanced Raman spectroscopy (SERS), comprises generating a structured surface (step A) by irradiating a surface of a mold material (e.g., a surface of a semiconductor material) with a plurality of short laser pulses. The term “short laser pulses,” as used herein, refers to laser pulses having durations less about a few nanoseconds (10⁻⁹ seconds), e.g., pulses with durations in a range of about 100 femtoseconds (10⁻¹⁵ seconds) to about one picosecond (10⁻¹² seconds). By way of example, in some embodiments, a silicon substrate can be exposed to a plurality of short pulses (e.g., pulses having durations in a range of about 100 femtoseconds to about 500 femtoseconds) while the surface is in contact with a fluid, e.g., water. The pulses cause a change in surface topography characterized by surface undulations (e.g., surface roughness) having amplitudes less than about a few microns (e.g., less than about 10 microns), and preferably less than about 1 micron, e.g., in a range of about 50 nm to about 200 nanometers.

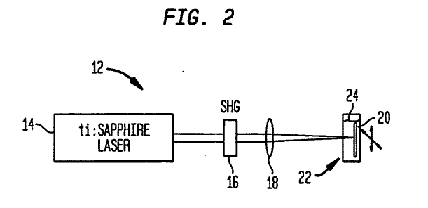

By way of example, FIG. 2 schematically depicts an exemplary optical system 12 suitable for processing a substrate (e.g., a semiconductor substrate) so as to generate micron-sized, and preferably submicron-sized, features (structures) on a surface thereof. For example, the features can include a plurality of spikes, e.g., substantially columnar structures extending from the surface to a height above the surface. The optical system 12 includes a Titanium-Sapphire (Ti:Sapphire) laser 14 for generating short laser pulses. By way of example, the Ti:Sapphire laser can generate laser pulses with a pulse width of about 80 femtoseconds at 800 nm wavelength (e.g., at an average power of 300 mW and at a repetition rate of 95 MHz). The pulses generated by the Ti:Sapphire laser can be applied to a chirped-pulse regenerative amplifier (not shown) that, in turn, can produce, e.g., 0.4 millijoule (mJ)), 100 femtosecond pulses at a wavelength of 800 nm and at a repetition rate of about 1 kilohertz.

The optical system 12 further includes a harmonic generation system 16 that receives the amplified pulses and doubles their frequency to produce, e.g., 100-femtosecond second-harmonic pulses at a wavelength of 400 nanometers. A lens 18 focuses the second-harmonic pulses onto a surface of a semiconductor sample 20, which can be disposed on a three-dimensional translation system (not shown). A glass liquid cell 22 can be coupled to the semiconductor sample so as to allow the sample surface exposed to the pulses to have contact with a liquid 24 (e.g., water) contained within the cell. Further details regarding methods and apparatuses for generating microns-sized, and preferably submicron-sized, features on a semiconductor surface can be found in co-pending U.S. patent application entitled “Femtosecond Laser-Induced Formation Of Submicrometer Spikes On A Semiconductor Substrate” having a Ser. No. 11/196,929, filed Aug. 4, 2005, which is herein incorporated by reference. U.S. Pat. No. 7,057,256 entitled “Silicon-Based Visible And Near-Infrared Optoelectronic Devices” and Published U.S. Patent Application No. 2003/00299495 entitled “Systems And Methods For Light Absorption and Field Emission Using Microstructured Silicon,” both of which are herein incorporated by reference, provide further disclosures regarding microstructuring silicon surfaces by application of short laser pulses.

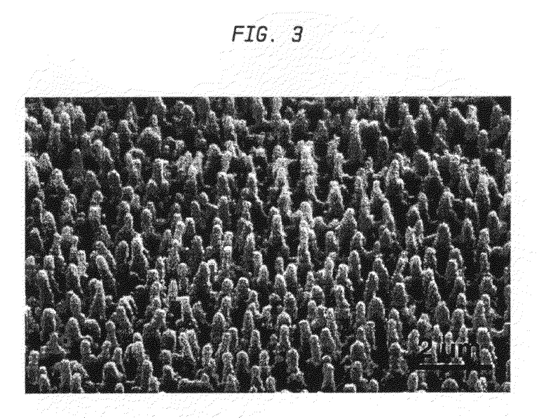

By way of illustration, FIG. 3 shows a silicon surface on which a plurality of nanosized features are generated via irradiation of the surface with a plurality of femtosecond laser pulses while the surface was in contact with water.

As discussed in more detail below, the structured surface can be utilized to form a polymeric substrate having a surface that replicates (either as a negative or a positive replication) the microns-sized, and preferably submicron-sized, features (structures) of the substrate surface. The nanostructured surface of the polymeric substrate can be coated with a thin metallic layer to generate a polymeric substrate suitable for use as a sensing substrate in a variety of applications, such as surface enhanced Raman spectroscopy. In many embodiments, the metallic layer exhibits microns-sized, and preferably submicron-sized, features that substantially correspond to those of the underlying polymeric surface. In some cases, a discontinuous metal coating is formed on the nanostructured polymeric surfaces, where the metallic portions of the coating exhibit micron-sized, or submicron-sized features that substantially correspond to those of the underlying polymeric surface.

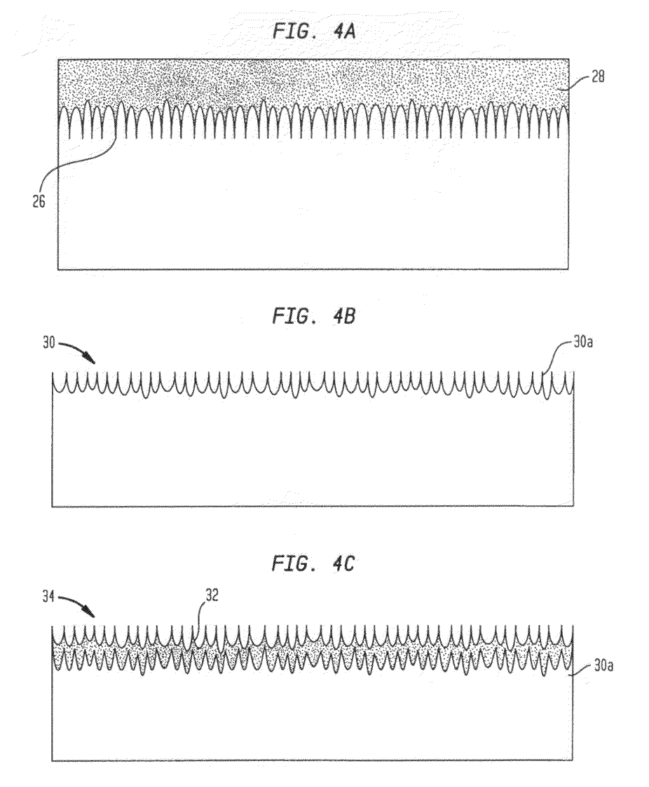

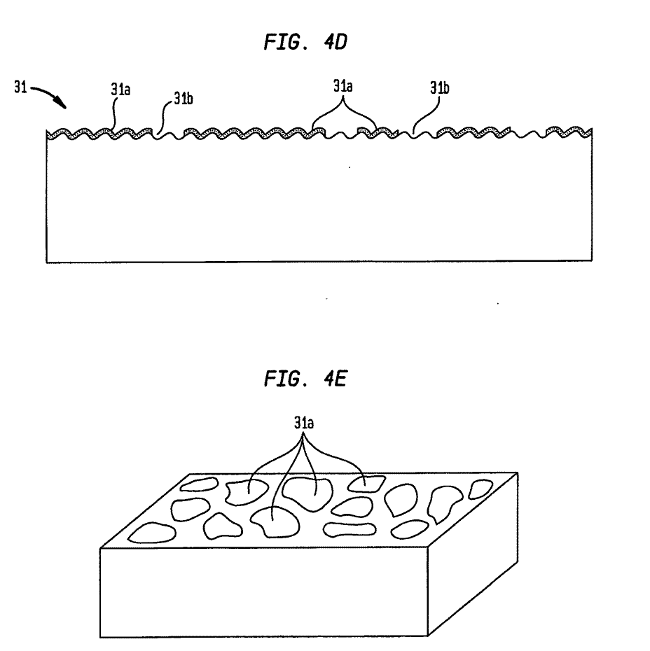

Referring again to the flow chart 10 of FIG. 1 as well as FIG. 4A, subsequent to forming micron-sized, and preferably submicron-sized, features on a semiconductor substrate's surface 26, in step B, a curable polymer 28 can be disposed (e.g., poured) over that surface, e.g., as a monolayer film. The polymer can be cured (step C), e.g., thermally and/or optically, to generate a negative mold of that surface, which provides negative replications of the semiconductor surface structures including the submicron-sized undulations of the underlying semiconductor surface. In some embodiments, prior to disposing the polymer on the surface, a surfactant, such as (tridecafluoro-1,1,2,2-tetrahydrooctyl)-1-trichlorosilane, is applied to the surface to facilitate the subsequent removal of the cured polymer as a negative mold of the surface. In some embodiments, the polymer is cured by applying heat thereto for a selected time period. By way of example, the polymer can be exposed to a temperature in a range of about 15° C. to about 100° C. for a time duration in a range of about 1 minute to about 48 hours. In other embodiments, an optically curable polymer can be employed that can be cured by exposure to radiation, e.g., UV radiation. In many cases, the curing process causes cross-linking of the polymer, thereby generating a polymeric substrate that retains its shape.

In general, a variety of curable polymers can be employed for generating the mold. In many embodiments, the curable polymer is a thermoplastic polymer that can be readily cured to retain its shape. Some examples of such polymers include, without limitation, hard-poly(dimethylsiloxane) (H-PDMS), or poly(dimethylsiloxane). In other embodiments, optically curable polymers, such as photoresists, SU-8, and polyurethane, can be employed.

Subsequent to curing the polymer, the cured polymer can be removed from the substrate surface (step D), e.g., by employing standard methods including the application of a salinization compound in some cases to assist with the separation process, to generate a polymeric substrate 30 having a surface 30a that is substantially a negative mold of the structured semiconductor surface, as shown schematically in FIG. 4B. In other words, the polymeric substrate's surface 30a exhibits microns-sized, and preferably submicron-sized, features (undulations) that are substantially negative replications of the structures on the substrate surface. By way of example, the spikes on the polymer surface substantially correspond to the hollow volumes between the spikes on the semiconductor nanostructured surface. The features of the substrate's surface 30a have preferably sizes (e.g., amplitudes) that are less than about 1 micron (e.g., in a range of about 1 to about 100 nanometers, and preferably in a range of about 1 nm to about 50 nm).

With continued reference to the flow chart 10 as well as FIG. 4C, in some embodiments, in a subsequent step (D), a thin metallic layer 32, e.g., silver, is disposed on the structured surface 30a of the polymeric substrate 30 to produce a sensing substrate 34 suitable for use in a variety of applications, such as surface enhanced Raman spectroscopy (SERS), e.g., in a manner discussed below. In many embodiments of the invention, the metallic layer 32 has a thickness in a range of about 10 nm to about 1000 nm, and more preferably in a range of about 50 nm to about 100 nm. The metallic surface is deposited over the polymeric substrate such that the resulting metallic layer would exhibit micron-sized, and preferably submicron-sized, undulations that correspond substantially to the structures on the underlying polymeric surface. In other words, the metallic layer provides a structured conductive surface (e.g., a conductive surface exhibiting micron-sized, and preferably submicron-sized, structures).

With reference to FIG. 4D, in some embodiments, rather than depositing a continuous metallic layer over the structured polymeric surface, a discontinuous metal coating 31 is disposed over that surface. As shown schematically in FIG. 4D, the discontinuous metal coating 31 can include a plurality of metallic regions 31a, e.g., in the form of aggregates of metal particles, covering portions of the underlying polymeric surface with a plurality of gaps 31b that leave the respective portions of the polymeric surface exposed. In some cases, the surface gaps, which can be randomly distributed through the coating, can have submicron-sized lateral dimensions, e.g., an average lateral dimension of a gap can be of the order of tens of nanometers.

Such discontinuous metal coatings can be generated, e.g., by evaporating a metal over the polymeric surface. By way of example, the amount of metal deposited on the polymeric structured surface can be controlled (e.g., by adjusting the evaporation rate and the deposition time) so as to form surface gaps in the metal coating, e.g., to generate a non-uniform coating punctuated by non-metalized portions. By way of example, in some cases, the quantity of the deposited metal on the structured polymeric surface can correspond to a quantity that would produce a uniform metal coating on a putative smooth surface (a surface lacking the aforementioned micron-sized or submicron-sized features) of the same polymeric material having the same dimensions as that of the structured polymeric surface with a thickness in a range of about 50 nm to about 500 nm, or in a range of about 50 nm to about 200 nm, or in a range of about 50 nm to about 80 nm.

The resulting substrate can be used in a variety of application, e.g., SERS. In some cases, regions in proximity of the surface gaps, e.g., nanosized gaps between metalized portions, can correspond to regions of large SERS enhancement.

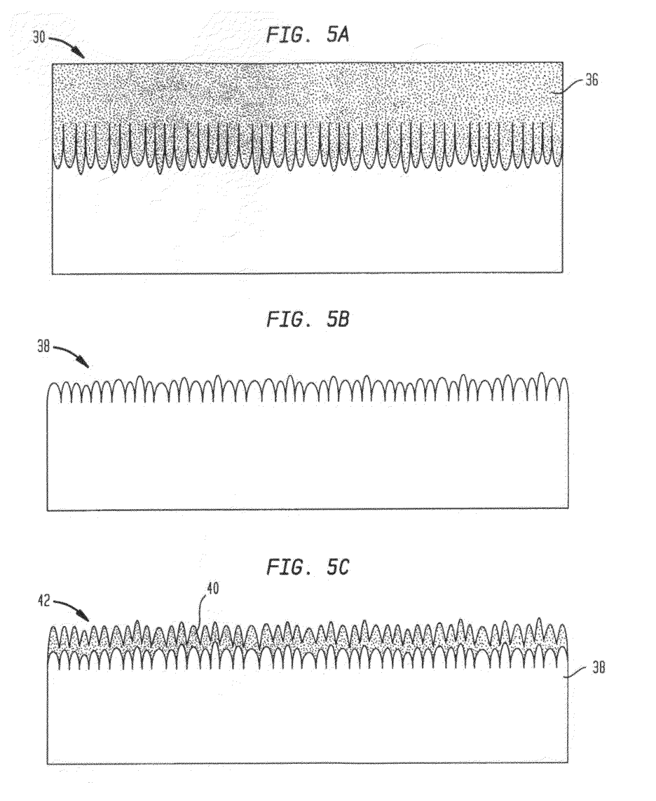

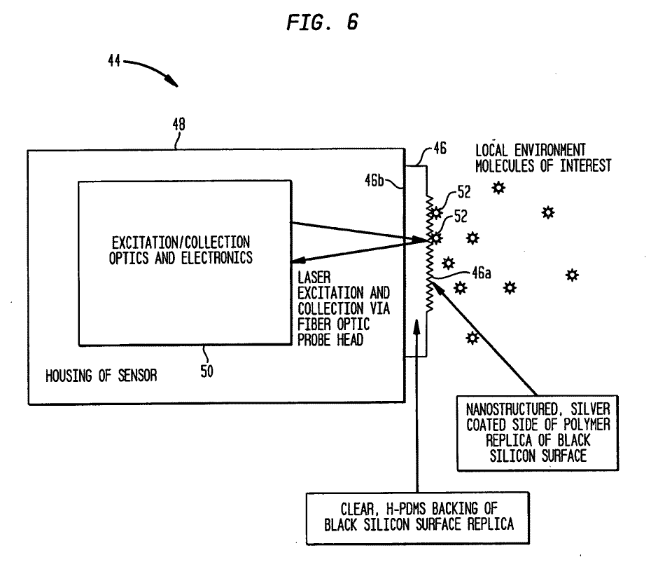

Alternatively, in some other embodiments, the negative polymeric mold is employed to fabricate a polymeric substrate having a surface that exhibits positive replications of the microns-sized, and preferably submicron-sized, features of the laser-irradiated semiconductor substrate surface. By way of example, as indicated in step (F) of the flow chart 10 and as shown schematically in FIG. 5A, a curable polymer 36 can be poured over the surface of the aforementioned polymeric substrate 30 (e.g., as a monolayer film), which has a surface that exhibits negative replications of the structured semiconductor surface, so as to fill the submicron-sized (and in some cases micron-sized) surface depressions. The curable polymer 36 can then be cured (step G) and separated from the polymeric substrate (step H) to generate another polymeric substrate 38. Similar to the curable polymer utilized to form the negative mold, the curable polymer 36 can be a thermally and/or an optically curable polymer, such as those listed above.

In many embodiments, however, the curable polymer 36 is selected to be different from the polymer from which the negative mold is formed so as to facilitate their separation after the polymer 36 is cured. Further, in some embodiments, a surfactant is applied to the negative mold polymeric surface to facilitate the separation of the two polymeric substrates after polymer 36 is cured. In some embodiments, the polymer 36 can be cured via a heat treatment, e.g., via exposure to a temperature in a range of about 15° C. to about 100° C. for a time duration in a range of about 1 minute to about 48 hours. In some other embodiments in which polymer 36 is optically curable, it can be cured by exposure to appropriate radiation, e.g., UV radiation.

Referring again to the flow chart 10 as well as FIG. 5C, subsequently in step (I), a thin metallic layer 40, e.g., silver or gold, can be disposed on the structured surface of polymeric substrate 38 having submicron-sized structures to generate a polymeric sensing substrate 42, which is suitable for use in surface enhanced Raman Spectroscopy. The thickness of the metallic layer can be in a range of about 10 nm to about 1000 nm, and preferably in a range of about 50 nm to about 120 nm. In some cases, a discontinuous metal coating can be formed on the structured surface of the polymeric substrate 38, e.g., in a manner discussed above.

Both of the polymeric sensing substrates 34 and 42 can be utilized in a variety of applications, such as SERS. As discussed in more detail below, the use of such polymeric sensing substrates of the invention advantageously results in significant enhancements in the signal-to-noise ratios (SNR) of SERS signals, e.g., via enhancements in Raman scattering cross sections, as the examples presented below illustrate. Further, the fabrication techniques of the invention for generating polymeric sensing substrates provide quick, simple, and inexpensive methods of mass producing structures suitable for use in Raman spectroscopy, or other applications. In particular, the molding process discussed above can be repeated multiple times (e.g., 50 times or more) per mold, before replicas would begin to exhibit substantial morphological differences from the original (the laser-irradiated substrate surface). In addition, hundreds of molds can be created from the original, yielding replication numbers of tens of thousands.

Moreover, the methods of the invention allow forming a metallic coating (e.g., a coating of Au, Ag, Pt, Rh, or other suitable metals) over the structured surfaces, e.g., via evaporation, sputtering, electroplating or other suitable metal deposition methods, such that the metal coating would exhibit the submicron-sized (and in some case micron-sized) features of the underlying surface. In this manner, the metal coating, which in many embodiments has a thickness comparable to, or smaller than, the wavelength of visible light, can provide an electric field enhancing conductive surface. Without being limited to any particular theory, the metal surface can exhibit surface plasmon resonance effects that can enhance electric fields in the vicinity of its mesostructures. Such enhancement of the electric field in the vicinity of the surface can advantageously be utilized in a variety of applications, such as those discussed below.

By way of example, FIG. 6 schematically depicts an optical system 44 in accordance with some embodiments of the invention that employs a sensing substrate 46 according to the teachings of the invention, such as the above polymeric sensing substrates 34 or 42 (e.g., with a continuous or discontinuous metal coating), for obtaining spectroscopic information regarding selected analytes of interest. The optical system 44 includes a housing 48 that can contain one or more modules 50 that provide excitation/collection devices and optics as well as ancillary electronics. The polymeric sensing substrate 46 having a metalized structured surface 46a is coupled to the housing such that its metalized surface faces the external environment while its opposed back surface 46b faces the interior of the housing. The polymeric substrate is substantially transparent to a probe radiation provided by the excitation/collection module such that it can be illuminated through a back surface thereof to cause excitation of one or more molecular species that are in contact, or in proximity, of its structured conductive surface.

In particular, the back surface 46b of the polymeric sensing substrate can be irradiated with a probe beam, e.g., a laser beam, where the probe beam can traverse through the substrate to interact, e.g., via near evanescent field, with external molecules that are in contact with, or in proximity of, the metalized surface. The contact with a structured conductive surface (e.g., a structured metal layer) is intended herein to refer not only to direct contact with the surface but also being in sufficient proximity of the surface such that the field-enhancing effects of the surface are discernible, including the cases where a thin dielectric layer may be covering the surface. The returning radiation, which carries a signature of this interaction can be collected and analyzed to obtain spectroscopic information regarding the molecules of interest 52 interacting with the probe beam. By way of example, an excitation laser beam can penetrate the metallic layer of the sensing substrate to interact with one or more Raman active constituents (e.g., molecular species) in the external environment that are in contact with the metallic layer. The Raman scattered photons can tunnel back through the metallic layer to be detected and analyzed, e.g., by a Raman spectrometer. As discussed in more detail below, the polymeric sensing substrate 46, and more particularly its metal-covered nanostructured surface 46a, can cause a significant enhancement in the Raman signal-to-noise ratio.

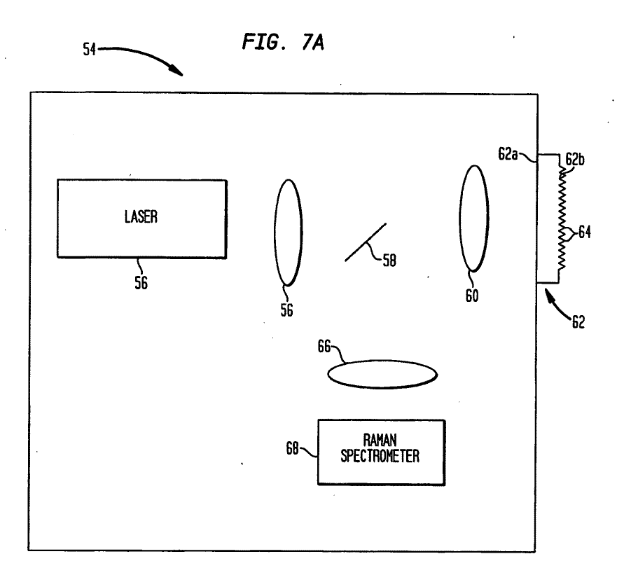

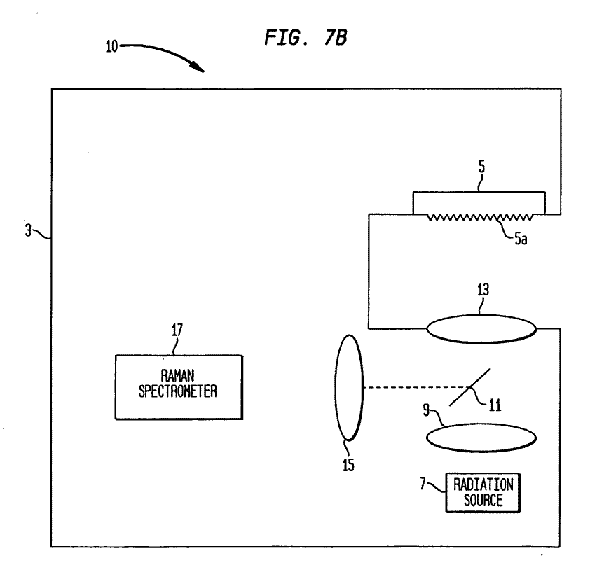

By way of further illustration, FIG. 7A schematically shows an optical system 54, which represents an exemplary implementation of the above optical system 44, for performing surface enhanced Raman spectroscopy (SERS). The system 54 includes a laser 56, e.g., a HeNe laser, for generating radiation, e.g., radiation at a wavelength of 633 nm when the source is a HeNe laser. A lens 56 (or a plurality of lenses in other implementations) directs the radiation (e.g., as a collimated beam) from the laser 54 to a beam splitter 58, which allows the passage of the radiation to another lens 60. The lens 60, in turn, focuses the radiation onto a back surface 62a of a polymeric sensing substrate 62, which is formed in accordance with the teachings of the invention, whose front surface 62b includes a plurality of metal-covered micron-sized, and preferably submicron-sized, ridges 64. The laser radiation travels through the polymeric substrate to activate Raman-active modes of one or more molecular species in contact with the sensing substrate's metallic surface. The radiation returning from the substrate that carries the Raman shifts (Stokes or anti-Stokes) indicative of the activated Raman modes is directed via the beam splitter 58 to a convergent lens 66 that, in turn, couples the radiation into a Raman spectrometer 68. The Raman spectrometer, in turn, analyzes the received radiation to provide Raman spectra of one or more Raman active modes of the molecular species that interacted with the probe radiation.

In some embodiments, the probe radiation is directed to a conductive (e.g., metalized) surface of a polymeric substrate exhibiting submicron-sized (and in some cases micron-sized) features, rather than the back surface of the substrate. By way of illustration, FIG. 7B schematically illustrates an optical device 1 according to another embodiment of the invention that includes a housing 3 to which a polymeric sensing substrate 5 according to the teachings of the invention, e.g., one of the above substrates 34 or 42, is coupled such that the metalized surface 5a of the polymer, which includes micron-sized, and preferably submicron-sized undulations, faces the external environment. A radiation source 7 can direct radiation via a collimator lens 9 and through a beam splitter 11 to a convergent lens 13, which, in turn, focuses the radiation to the structured surface 5a of the polymeric substrate. The radiation can excite one or more Raman active modes of one or more molecular species in contact with the polymeric surface 5a. The returning radiation carrying the Raman shifts can be collected by the lens 13 and directed by the beam splitter 11 to a lens 15, which focuses the returning radiation onto a Raman spectrometer 17. The Raman spectrometer can, in turn, generate one or more Raman spectra of the molecular species.

The applications of the sensing substrates of the invention are not limited to those discussed above. For example, the metalized polymeric substrates of the invention can find a variety of uses in areas that require intense optical fields at a surface.

The following example provides further illustration of the salient aspects of the invention, and is provided only for illustrative purposes and to show the efficacy of the methods and systems according to the invention for significantly enhancing the signal-to-noise ratio in SERS. It should, however, be understood that the example is not intended to necessarily indicate the optimal results (e.g., optimal signal-to-noise ratios) that can be achieved by employing the methods and systems of the invention, or the full range of analytes that can be examined.

### Example

A polymeric sensing substrate having a surface with submicron-sized ridges was formed by utilizing a hard-poly(dimethylsiloxane) polymer. The polymer was employed to replicate the submicron-sized features formed on a surface of a silicon wafer via exposure to femtosecond pulses. The structured silicon surface was generated by irradiating a silicon surface with a plurality of femtosecond laser pulses with a pulse width of about 100 femtoseconds while the surface was in contact with water such that each surface location was exposed to about 500 laser pulses. A surfactant, namely, (tridecafluoro-1,1,2,2-tetrahydrooctyl)-1-trichlorosilane, was applied to the nanostructured silicon surface and a film of the polymer (having an approximate thickness of about 1 mm) was poured on that surface. The polymer was subsequently cured via heat treatment at a temperature of about 40 deg. Celsius for a duration of about 8 hours, to form a negative polymeric mold of the nanostructured semiconductor surface. The cured polymer was removed from the semiconductor substrate, and the polymeric surface exhibiting nanosized ridges was metalized, via thermal deposition, by evaporating silver onto the surface at an evaporation rate of about 1.5 angstroms per second for a time period of about 8.75 minutes to generate a polymeric sensing substrate with a surface exhibiting metallic mesostructures.

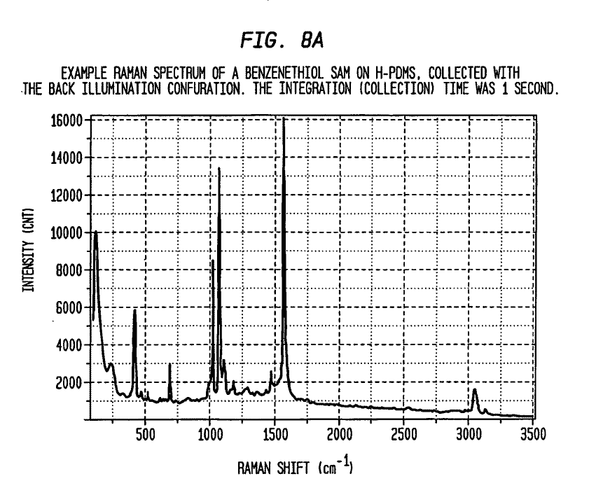

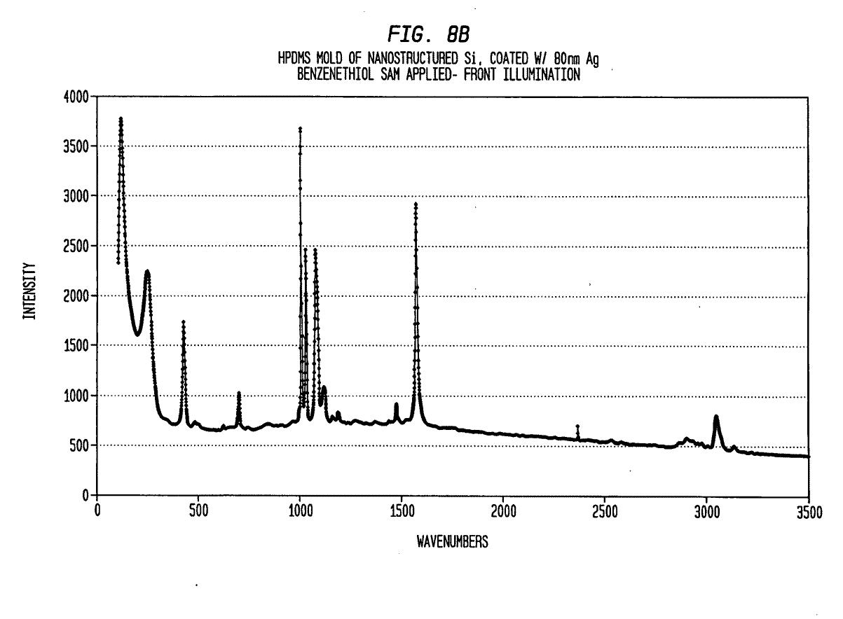

The polymeric sensing substrate was employed to obtain Raman spectrum of a self assembled monolayer (SAM) of benzenethiol. By way of example, FIG. 8A shows such a spectrum that was collected using a Jobin Yvon LabRam ARAMIS Raman microscope with 633 nm HeNe laser excitation. The microscope was operated with no pinhole in place (that is, not in confocal mode). A 10×, 0.25 NA objective was employed to focus and collect the light. The integration (collection) time was about 1 second. The reference sample was a 500 micron thick cell of neat benzenethiol. The spectrum shown in FIG. 8A was obtained by utilizing back illumination (i.e., illumination of the back surface of the polymeric substrate).

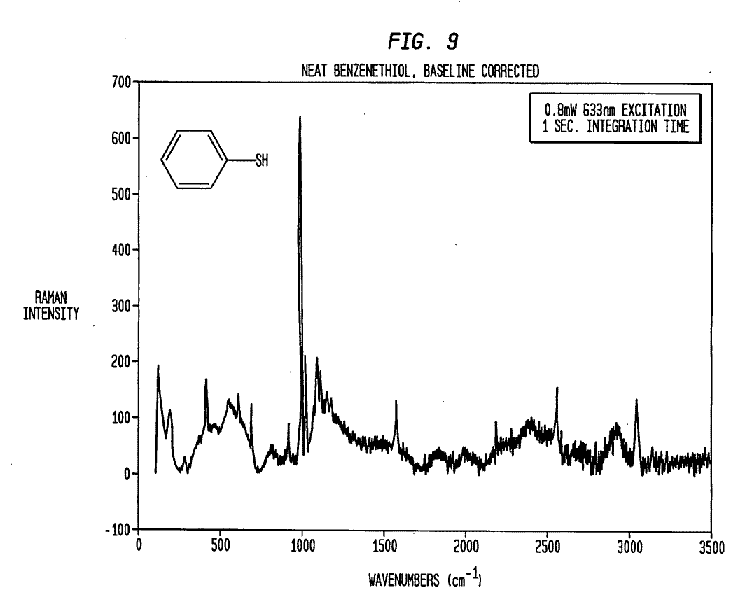

Raman spectrum of a self assembled monolayer of Benzenethiol was also obtained by employing front illumination of the polymeric sensing substrate (illumination of the metallic surface). This spectrum is shown in FIG. 8B. In addition, as a control, Raman spectrum of bulk, neat Benzenethiol (shown in FIG. 9) was obtained by employing the same spectrometer. These spectra were utilized to calculate Raman scattering molecular cross section enhancement factor (EF) obtained by utilizing some polymeric substrates in accordance with the teachings of the invention.

A self-assembled monolayer (SAM) of benzenethiol was used to quantify the number of molecules present on the structured surfaces. The molecular packing density of benzenethiol on a silver surface is known to be approximately 6.8×10¹⁴ cm⁻². For the Raman spectra of the SAM on the silver coated structured surfaces, the integrated peak intensity of a single Raman band was normalized with a Raman band from the spectrum of a sample of neat benzenethiol so as to derive an enhancement factor of the scattering cross section per individual molecule. With knowledge of the neat sample's refractive index, molar volume, and probed volume, the EF were determined. Table 1 below shows cross section factor versus Raman band.

TABLE 1

| | EF | EF |
|---|---|---|
| Substrate | (1000 cm⁻¹ band) | (1572 cm⁻¹ band) |
| structured polymer | 1.65 × 10¹⁰ | 1.07 × 10¹¹ |
| (front illumination) | | |
| structured polymer | 2.45 × 10¹⁰ | 7.76 × 10¹⁰ |
| (back illumination) | | |

The variation in enhancement factor versus Raman band is understood to be due to the tensorial nature of the molecular polarizability (α) and the inhomogeneous molecular orientation distribution of the SAM on the silver coated substrates. The calculation (normalization) method used here involves integrating over the volume of a focused Gaussian beam. The above table shows that significant enhancements in EF can be obtained with structured polymeric substrates.

It should be understood that the enhancement factor can be defined differently than that discussed above, which can lead to different numerical values for the enhancement factor. Regardless, the above exemplary data shows that a significant enhancement factor can be achieved by the use of the polymeric sensing substrate. By way of example, an article entitled “Surface Enhanced Raman Scattering Enhancement Factors: A Comprehensive Study,” authored by Le Ru et al. and published in J. Phys. Chem. C 2007, 111, 13794-13803 describes various definitions of SERS enhancement factors. This article in herein incorporated by reference in its entirety.

Those having ordinary skill in the art will appreciate that various modifications can be made to the above embodiments without departing from the scope of the invention.

1. A method of forming a polymeric substrate, comprising
irradiating a mold surface with a plurality of short laser pulses to form nanosized structures on said surface,
disposing a curable polymer over at least a portion of said irradiated mold surface to generate a negative polymeric mold of said surface, and
utilizing said negative mold to fabricate a polymeric substrate.

2. The method of claim 1, wherein said polymeric substrate comprises a surface exhibiting replications of structures on at least a portion of said irradiated surface.

3. The method of claim 1, further comprising depositing a metallic coating on said surface of said polymeric substrate.

4. The method of claim 1, wherein said curable polymer comprises a thermoplastic polymer, or an optically curable polymer.

5. The method of claim 1, further comprising selecting said curable polymer to be any of hard-poly(dimethylsiloxane), PDMS, polyurethane, poly(dimethylsiloxane), photoresist.

6. The method of claim 1, further comprising exposing said mold surface to a liquid during said irradiation.

7. The method of claim 6, wherein said liquid comprises any of water, alcohol, or oil.

8. The method of claim 1, further comprising curing said curable polymer disposed on said irradiated surface.

9. The method of claim 8, wherein said curing step comprises subjecting said curable polymer to a temperature in a range of about 15° C. to about 100° C. for a time period in a range of about 1 minute to about 48 hours.

10. The method of claim 8, wherein said curing step comprises exposing said polymer to radiation for a time period in a range of about 1 minute to about 48 hours.

11. The method of claim 10, wherein said radiation comprises ultraviolet radiation.

12. The method of claim 8, further comprising removing said cured polymer from said substrate to generate the negative mold.

13. The method of claim 12, wherein the step of generating said polymeric substrate comprises disposing another curable polymer over a surface of said negative mold.

14. The method of claim 13, further comprising curing said another curable polymer to generate a positive replica of said semiconductor surface.

15. The method of claim 3, wherein said metallic coating comprises a discontinuous metallic coating.

16. The method of claim 3, wherein said metallic coating comprises a continuous metallic layer.

17. The method of claim 1, wherein said mold surface comprises any of a semiconductor surface, a glass surface or a metal surface.

18. A method of fabricating a polymeric substrate, comprising
exposing a semiconductor surface to a plurality of short laser pulses to generate any of micron-sized and/or submicron-sized structures on said surface,
utilizing said structured semiconductor surface to generate a polymeric substrate having a surface exhibiting micron-sized and/or submicron-sized features as substantially negative or positive replications of the submicron-sized structures on the semiconductor surface, and
depositing a metal coating over the structured polymeric surface.

19. The method of claim 18, wherein said metal coating comprises a substantially continuous metal layer having a thickness in a range of about 10 nm to about 1000 nm.

20. The method of claim 18, wherein said metal coating comprises a discontinuous metal coating.

21. The method of claim 20, wherein said metal coating substantially exhibits submicron-sized features corresponding to the submicron-sized features on the underlying polymeric surface.

22. The method of claim 21, wherein generating the polymeric substrate comprises disposing a first curable polymer on said structured semiconductor surface.

23. The method of claim 22, further comprising curing said polymer and removing said cured polymer from the semiconductor substrate to form a polymeric substrate having submicron-sized features as negative replications of the submicron-sized features on the semiconductor substrate.

24. The method of claim 23, further comprising disposing a second curable polymer over said structured polymeric surface.

25. A method of fabricating a polymeric article, comprising
forming a textured surface by irradiating a substrate surface with a plurality of short laser pulses,
generating a polymeric negative mold of at least a portion of said textured surface, and
utilizing said negative mold to generate a polymeric reproduction of said portion of the textured surface.

26. The method of claim 25, further comprising contacting said surface with a liquid during said irradiation of the surface.

27. The method of claim 26, further comprising selecting said liquid to be any of a polar or non-polar liquid.

28. The method of claim 26, wherein said liquid comprises any of water, alcohol, or oil.

29. An optical system, comprising
a sensing substrate comprising a polymeric material having at least an electrically conductive surface exhibiting a plurality of micron-sized or submicron-sided ridges, said conductive surface being adapted for contact with one or more analytes,
a radiation source for directing radiation to said substrate so as to cause interaction of the radiation with one or more analytes in contact with the metal-covered substrate surface, and
an analyzer adapted to detect at least a portion of radiation returning from said substrate in response to said radiation to obtain spectroscopic information regarding at least one of said analytes.

30. The optical system of claim 29 wherein said conductive surface comprises a metallic layer having a thickness in a range of about 10 nm to about 1000 nm.

31. The optical system of claim 29, wherein said conductive surface comprises a discontinuous metallic coating.

32. The optical system of claim 29, wherein said polymeric material is substantially transparent to said radiation.

33. The optical system of claim 32, wherein said source direct the radiation to any of said conductive surface or a back surface of said substrate opposed to said conductive surface.

34. The optical system of claim 29, wherein said analyte comprises a Raman active constituent and said spectroscopic information comprises one or more surface enhanced Raman spectra of said constituent.

35. The optical system of claim 34, wherein said analyzer comprises a Raman spectrometer.

36. The optical system of claim 35, wherein said analyzer is configured to compare said one or more Raman spectra of said constituent with one or more reference spectra so as to obtain desired information regarding said at least one analyte.

37. The optical system of claim 29, wherein said radiation source is capable of emitting radiation with one or more wavelengths in a range of about 200 nm to about 2000 nm.

38. The optical system of claim 36, wherein said analyzer employs the information regarding said at least one analyte to determine selected information regarding an environment containing said analyte.

39. A method of performing surface enhanced Raman spectroscopy (SERS), comprising
providing a polymeric substrate comprising a textured surface that is a replica of a textured surface generated by irradiating a substrate surface with a plurality of femtosecond laser pulses, said polymeric textured surface having a metallic coating on at least a portion thereof,
placing at least a portion of said metallic layer in contact with a Raman active analyte,
directing radiation to said textured polymeric surface, and
analyzing at least a portion of radiation returning from said polymeric surface in response to illumination to obtain one or more Raman spectra of said analyte.

40. A sensing substrate, comprising
a polymeric substrate having a surface exhibiting micron-sized and/or submicron-sized structures,
a metallic coating disposed on said surface to generate a conductive coating exhibiting structures substantially corresponding to those of the polymeric surface.

41. The substrate of claim 40, wherein said metallic coating comprises a discontinuous coating.

42. The sensing substrate of claim 40, wherein said metallic coating comprises a metal layer having a thickness in a range of about 10 nanometers to about 1000 nanometers.

43. A method for sensing at least one of the presence and quantity of an analyte, wherein the method comprises:
providing a casting base that has been structured using laser processing so as to provide at least one casting base patterned surface;
duplicating the base by casting so as to provide a working base having at least one working patterned surface;
applying a metal to the at least one working patterned surface so as to provide at least one metalized patterned surface; and
using the at least one metalized patterned surface as a substrate for performing a diagnostic assay of the analyte.
